(19) United States
(12) Patent Application Publication
(10) Pub. No.: US 2005/0097326 A1
(43) Pub. Date: May 5, 2005

(54) Method of securely transferring programmable packet using digital signatures having access-controlled high-security verification key

(76) Inventors: Young Soo Kim, Daejeon-city (KR); Jong Wook Han, Daejeon-city (KR); Dong il Seo, Daejeon-city (KR); Seung Won Sohn, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/836,928

(22) Filed: Apr. 30, 2004

(30) Foreign Application Priority Data
Nov. 5, 2003 (KR) 2003-78118

(51) Int. Cl. H04L 9/00

(52) U.S. Cl. 713/171

(57) ABSTRACT

Provided is a method of securely transferring a programmable packet using digital signatures having an access-controlled high-security verification key, by which the programmable packet is transferred using digital signatures having a sufficiently long signing key and an access-controlled high-security verification key in an environment of a programmable network that only a transfer node knows an address of a final receipt node and intermediate receipt nodes are not determined.

This application claims the priority of Korean Patent Application No. 2003-78118, filed on Nov. 5, 2003, in the Korean Intellectual Property Office, the disclosure of which is incorporated herein in its entirety by reference.

### BACKGROUND OF THE INVENTION

1. Field of the Invention

The present invention relates to a method of protecting a programmable network, and more particularly, to a method of protecting a programmable packet to securely transfer the programmable packet (or an active packet).

2. Description of the Related Art

Recently, programmable networks have been emerged as new approaches to network structures. In the programmable networks, nodes can perform calculation with respect to user data and users provide their programs to the nodes for the calculation, thus programming the networks. As such, the programmable networks are useful to add and provide new services without physical action or hardware modification.

Such flexibility of the programmable networks serves as a strong advantage, but may serve as a disadvantage in some cases. This is because programs carried by programmable packets use common resources at nodes, may have an influence upon numerous important systems, and thus may cause significant damage to the programmable networks. Therefore, security requirements should be very strictly defined for a calculation environment that codes contained in packets can be executed.

To solve such a problem, solutions like encryption techniques have been suggested. However, considering characteristics of the environment of the programmable networks, such solutions are subject to limitations of security problems. This is because programmable packets containing executable codes should be executed at not only end nodes like transfer nodes or receipt nodes but also intermediate nodes and thus existing encryption protocols cannot be applied, the existing encryption protocols in which mutual authentication is performed between the transfer nodes and the receipt nodes and information is transferred to the receipt nodes while the transfer nodes know information of the receipt nodes. Therefore, there is a need for a new method of securely transferring programmable packets in an environment of the programmable networks that transfer nodes know addresses of final receipt nodes while intermediate receipt nodes are not determined.

### SUMMARY OF THE INVENTION

The present invention provides a method of securely transferring programmable packets, by which programmable nodes are verified using digital signatures having a high-security signing key.

The present invention also provides both integrity and confidentiality using sufficiently long signing key and verification key.

The present invention also provides a method, by which a storage server for verification keys (hereafter, referred to as an SSVK) is provided and only authorized programmable nodes verify signatures and execute codes.

The present invention also provides a computer readable recording medium having embodied thereon a computer program for the methods.

According to an aspect of the present invention, there is provided a method of registering a programmable node to transfer a programmable packet, the method comprising (a) creating a signing key and a verification key of the programmable node; (b) showing identification information and the verification key of the programmable node to a storage server for verification keys and requests for registration; (c) storing in a database of the storage server the signing key of the programmable node in which the identification information and the verification key are signed by a signing key of the storage server; (d) the storage server issuing the signing key of the programmable node and the verification key of the storage server to the programmable node; and (e) storing the signing key of the programmable node and the verification key of the storage server in the programmable node.

According to another aspect of the present invention, there is provided a method of transferring a programmable packet, the method comprising (a) calculating a redundancy function value of a target program code at a start node and signing the redundancy function value using a signing key of the start node; (b) creating a programmable packet based on an IP address, a final destination IP address, and information required for signing and verification that belong to the start node and transferring the created programmable packet to a neighboring node; (c) forwarding the programmable packet to the neighboring node, if a receipt node that receives the programmable packet transferred in step (b) is a general node; (d) creating a programmable packet containing a program code included in the programmable packet and an intermediate execution result of the program code and transferring the programmable packet to the neighboring node, if a receipt node that receives the programmable packet transferred in step (b) is not a general node; and (e) executing the program code included in the programmable packet and obtaining a final result, if a receipt node that receives the programmable packet transferred in step (b) or (d) is a final node.

### BRIEF DESCRIPTION OF THE DRAWINGS

The above and other aspects and advantages of the present invention will become more apparent by describing in detail an exemplary embodiment thereof with reference to the attached drawings in which:

FIG. 1 illustrates the environment of a programmable network and a flow of programmable packets according to the present invention;

FIG. 2 is a flowchart illustrating a registration procedure of programmable nodes according to an embodiment of the present invention; and

FIGS. 3A and 3B illustrate a flowchart illustrating detailed operations of a programmable packet transfer protocol according to an embodiment of the present invention.

### DETAILED DESCRIPTION OF THE INVENTION

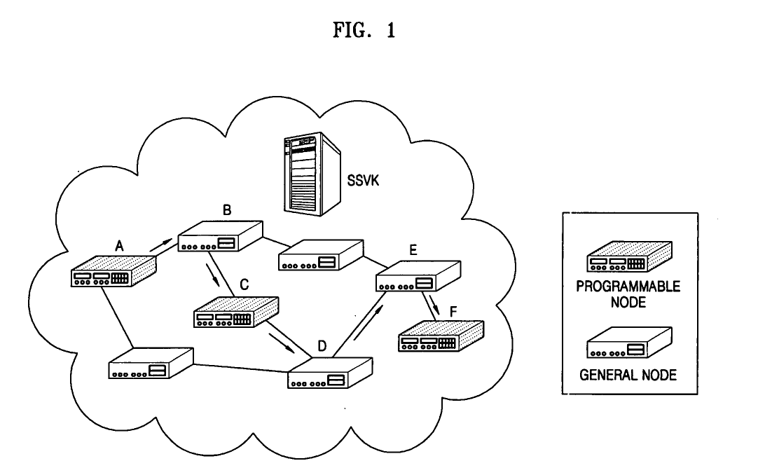

FIG. 1 illustrates the environment of a programmable network and a flow of programmable packets according to the present invention. Referring to FIG. 1, the programmable network comprises general nodes, programmable nodes (or active nodes), a storage server for verification keys (hereafter, referred to as an SSVK).

The general nodes indicate existing routers or switches and store-forward packets. The programmable nodes indicate routers or switches that can execute programmable packets and store-compute-forward packets. The SSVK stores received verification keys of nodes and, when a verification key is requested for signature verification, the SSVK identifies the subject of the request and transfers the verification key.

As shown in FIG. 1, the programmable nodes and the general nodes coexist in the programmable network. In this case, a programmable node A knows only an IP address of a final receipt programmable node F and does not know information of nodes B, C, D, and E that are present between the programmable node A and the final receipt programmable node F. Also, the nodes B, D, and E, which are general nodes, simply forward programmable packets that arrive from the programmable node A to adjacent nodes.

In the present invention, to protect programmable packets in the environment of the programmable network, a digital signature scheme giving message recovery is used, in which a signed message (here, a program code (PC)) is recovered from a signature. The digital signature scheme giving message recovery does not need information at the time of message signature for verification. To this end, a heuristically existentially unforgeable digital signature technique is used.

In the digital signature technique used in the present invention, it is assumed that a redundancy function R and an inverse function thereof R⁻¹ are public information and the length of a signing key is similar to that of a verification key (i.e., security of the signing key is similar to that of the verification key). Also, not to consider fragmentation, it is assumed that one program code has a size that can be contained in a single programmable packet.

In the present invention, the first transfer programmable node (i.e., the node A) that creates a programmable packet and transfers the programmable packet is intended to securely transfer the programmable packet containing a PC to a final destination programmable node (i.e., the node F), in which not only the final destination node but also all the intermediate programmable nodes that are present in a transfer path execute the programmable packet and let the final destination node know intermediate results. To this end, it is assumed that there is no internal dishonesty (i.e., registered nodes do not a dishonest thing) and an SSVK should not be damaged. Therefore, when the SSVK is damaged, it is excluded from security analysis. Assuming that the above conditions are satisfied, a method of transferring programmable packets is as follows.

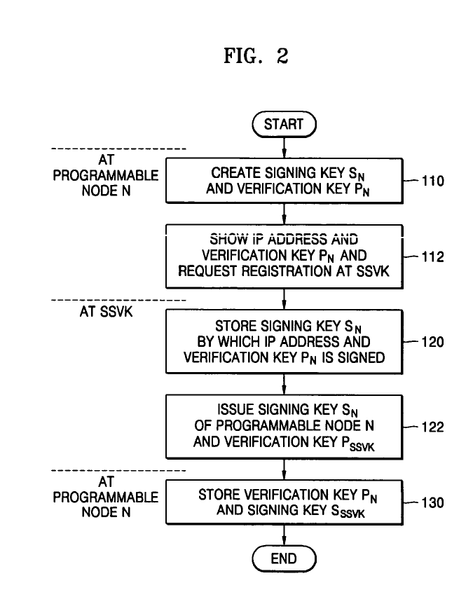

FIG. 2 is a flowchart illustrating a registration procedure of programmable nodes according to an embodiment of the present invention. In FIG. 2, an initializing procedure of registering a programmable node N in an SSVK and a procedure of creating a signing key and a verification key are illustrated.

Referring to FIG. 2, when the programmable node N desires to be initially registered in the SSVK, it creates a signing key S_{N} of the programmable node N used for signing of a target program and a verification key P_{N} of the programmable node N to be used by other programmable nodes for signature verification, in step 110. Then the programmable node N shows its IP address and the verification key P_{N} to the SSVK and requests registration, in step 112. Here, the IP address of the programmable node N represents inherent information of the programmable node N and thus is used as identification information ID_{N} of the programmable node N.

The SSVK signs the IP address (i.e., ID_{N}) of the programmable node N and the verification key P_{N}, using its own signing key SSVK, and stores the signing key S_{N} which is created by the signing, in a database of the SSVK, in step 120. The signing key S_{N} created in step 120 is expressed as follows.
S_{N}={Sig_{S}_{_{SSVK}}(R(ID_{N}, P_{N}))} (1),

where R(M) represents a redundancy function of M and Sig_{S}_{_{N}} (M) represents a signature of M using the signing key S_{N} of the programmable node N.

Next, the SSVK issues the signing key S_{N} of the programmable node N and its verification key P_{SSVK} to the programmable node in step 122 and the programmable node N stores the verification key P_{SSVK} of the SSVK, which is issued in step 122, and its signing key S_{N} in step 130.

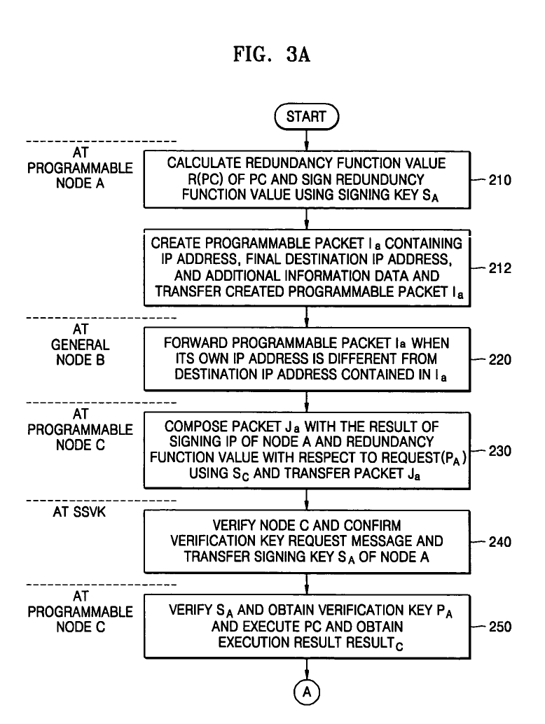

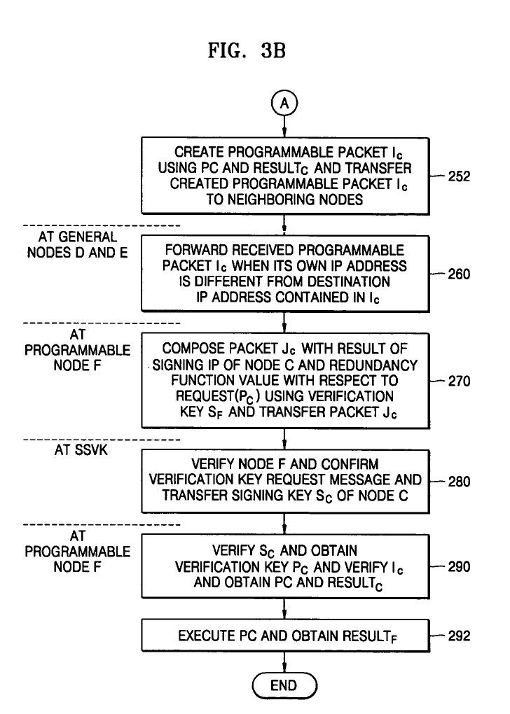

FIGS. 3A and 3B illustrate a flowchart illustrating detailed operations of a programmable packet transfer protocol according to an embodiment of the present invention. Referring to FIGS. 1, 3A and 3B, the programmable node A securely transfers the programmable packet containing the PC to the final destination programmable node F, in which not only the final destination programmable node F but also all the intermediate programmable nodes that are present in a transfer path execute the programmable packet and let the final destination programmable node F know intermediate results. Here, the PC is contained in a payload field of the programmable packet.

To this end, the programmable node A calculates a redundancy function value R(PC) of a target PC and signs the functional value, in step 210. Also, the programmable node A creates a programmable packet Iₐ containing its IP address, a final destination IP address, and additional information data DATA (e.g., used signing algorithms) required for signing and verification and transfers the created programmable packet Iₐ to a neighboring node, i.e., the general node B, in step 212.

The programmable packet Iₐ created in step 212 is expressed as follows.
Ia={Sig_{S}_{_{A}}(R(PC)), ID_{A}, ID_{F}, DATA} (2),

where R(M) represents a redundancy function of M and Sig_{S}_{_{N}} (M) represents a signature of M using the signing key S_{N} of the programmable node N.

Since the IP address of the general node B that receives the programmable packet Iₐ from the programmable node A is different from a destination address included in the programmable packet Iₐ, the general node B forwards the programmable packet Iₐ to a neighboring node, i.e., the programmable node C, in step 220.

Once the programmable node C receives the programmable packet Iₐ, it recognizes that the received programmable packet Iₐ is transferred from the programmable node A and the final destination is the programmable node F. At this time, since the programmable node C needs the verification key P_{A} of the transfer node A to verify a signature included in the programmable packet Iₐ and execute the PC, it creates a packet Jₐ and transfers the packet Jₐ to the SSVK, in step 230.

As shown in Equation 3 below, the packet Jₐ is composed of a result of signing the IP address ID_{A} of the programmable node A and a redundancy function value of a verification key request message REQUEST (P_{A}) using a verification key S_{C} of the programmable node C and an IP address ID_{C} of the programmable node C.
Ja={(Sig_{S}_{_{C}}(R(REQUEST(P_{A}), ID_{A}))), ID_{C}} (3),

where R(M) represents a redundancy function of M, Sig_{S}_{_{N}} (M) represents a signature of M using the signing key S_{N} of the programmable node N, and REQUEST (P_{A}) represents a verification key request message that requests the SSVK to issue the verification key P_{N} of the programmable node N.

The SSVK that receives the packet Jₐ from the programmable node C confirms based on the IP address ID_{C} of the programmable node C that the programmable node C is a registered active node. Then, the SSVK verifies the signature using the verification key P_{C} of the programmable node C stored in step 130 of FIG. 2, as shown in Equation 4, and recognizes that the programmable node C desires the verification key of the programmable node A.

$$\begin{matrix}Ka = {R}^{- 1} \{ {Ver}_{{P}_{C}} ( {Sig}_{{S}_{C}} ( R ( REQUEST ( {P}_{A} ) , {ID}_{A} ) ) ) \} \\ = ( REQUEST ( {P}_{A} ) , {ID}_{A} )\end{matrix} \qquad ( 4 )$$

After completion of confirmation of verification key request, the SSVK copies the signing key S_{A} of the programmable node A from the database and transfers the signing key S_{A} to the IP address of the programmable node C, in step 240. At this time, the transferred signing key S_{A} with respect to the verification key of the programmable node A is expressed as follows.
S_{A}={Sig_{S}_{_{SSVK}}(R(ID_{A}, P_{A}))} (5),

where in Equations 4 and 5, REQUEST (P_{N}) represents a verification key request message that requests the SSVK to issue the verification key P_{N} of the programmable node N, R(M) represents a redundancy function of M, R⁻¹(M) represents an inverse redundancy function of M, Sig_{S}_{_{N}} (M) represents a signature of M using the signing key S_{N} of the programmable node N, and Ver_{P}_{_{N}} (S) represents verification of a signature S using the verification key P_{N} of the programmable node N.

The programmable node C that receives the signing key S_{A} with respect to the verification key of the programmable nod A from the SSVK verifies the signing key S_{A} of the programmable node A using the verification key P_{SSVK} of the SSVK which is previously stored in step 130 of FIG. 2, as follows.
Ta=R⁻¹{Ver_{P}_{_{SSVK}}(S_{A})}=(ID_{A}, P_{A}) (6)

After the signing key S_{A} of the programmable node A is verified using Equation 6, the verification key P_{A} of the programmable node A is obtained using a redundancy function.

The programmable node C verifies the programmable packet Iₐ using the verification key P_{A} of the programmable node A as follows.
Qa=R⁻¹{Ver_{P}_{_{A}}(Sig_{S}_{_{A}}(R(PC)))}=PC (7)

After the programmable packet Iₐ is verified using Equation 7, the programmable node C executes the PC included in the verified programmable packet Iₐ and obtains an execution result RESULT_{C} of the PC, in step 250.

In Equations 6 and 7, R⁻¹(M) represents an inverse redundancy function of M, Sig_{S}_{_{N}} (M) represents a signature of M using the signing key S_{N} of the programmable node N, and Ver_{P}_{_{N}} (S) represents verification of a signature S using the verification key P_{N} of the programmable node N.

In this case, since the programmable node C is not a final destination of the programmable packet Iₐ, the programmable node C creates a programmable packet I_{C} containing its IP address, its final destination IP address, and additional information data DATA required for signing and verification to transfer the PC and the execution result RESULT_{C} thereof and transfers the created programmable packet I_{C} to neighboring nodes (e.g., general nodes D and E), in step 252. The programmable packet I_{C} created in step 252 is expressed as follows.
I_{C}={Sig_{S}_{_{C}}(R(PC, RESULT_{C})), ID_{C}, ID_{F}, DATA} (8),

where RESULT_{C} represents a result of executing the PC by the programmable node C, R(M) represents a redundancy function of M, and Sig_{S}_{_{N}} (M) represents a signature of M using the signing key S_{N} of the programmable node N.

Since the general nodes D and E that receive the programmable packet I_{C} from the programmable node C have IP addresses (ID_{D} and ID_{E}) that are different from the destination addresses contained in the programmable packet I_{C}, they forward the received programmable packet I_{C} to their neighboring nodes (e.g., the programmable node F), in step 260.

The programmable node F that receives the programmable packet I_{C} recognizes that the received programmable packet I_{C} is received from the programmable node C and the final destination of the received programmable packet I_{C} is the programmable node F. To verify a signature contained in the programmable packet I_{C} and execute the PC contained in the programmable packet I_{C}, the verification key P_{C} of the programmable node C is required. Thus, the packet J_{C} is created as follows and transferred to the SSVK, in step 270.

The packet J_{C} is composed of a result of signing the IP address ID_{C} of the programmable node C and a redundancy function value of a verification key request message REQUEST (P_{C}) using a verification key S_{F} of the programmable node F and an IP address ID_{F} of the programmable node F.
Jc={(Sig_{S}_{_{F}}(R(REQUEST(P_{C}), ID_{C}))), ID_{F}} (9),

where REQUEST (P_{N}) represents a verification key request message that requests the SSVK to issue the verification key P_{N} of the programmable node N and Sig_{S}_{_{N}} (M) represents a signature of M using the signing key S_{N} of the programmable node N.

The SSVK that receives the packet J_{C} from the programmable node F confirms based on the IP address ID_{F} of the programmable node F that the programmable node F is registered programmable node. Then the SSVK verifies the signature using the verification key P_{F} of the programmable node F which is previously stored in step 130 of FIG. 2, as shown in Equation 10, and recognizes that the programmable node F requires the verification key of the programmable node C.

$$\begin{matrix}Kc = {R}^{- 1} \{ {Ver}_{{P}_{F}} ( {Sig}_{{S}_{F}} ( R ( REQUEST ( {P}_{C} ) , {ID}_{C} ) ) ) \} \\ = ( REQUEST ( {P}_{C} ) , {ID}_{C} )\end{matrix} \qquad ( 10 )$$

After the request for the verification key is confirmed, the SSVK copies the signing key S_{C} with respect to the verification key of the programmable node C from the database and transfer the copied signing key S_{C} to the IP address ID_{F} of the programmable node F, in step 280. At this time, the transferred signing key S_{C} of the verification key of the programmable node C is expressed as follows:
S_{C}={Sig_{S}_{_{SSVK}}(R(ID_{C}, P_{C}))} (11)

In Equations 10 and 11, REQUEST (P_{N}) represents a verification key request message that requests the SSVK to issue the verification key P_{N} of the programmable node N, R(M) represents a redundancy function of M, R⁻¹(M) represents an inverse redundancy function of M, Sig_{S}_{_{N}} (M) represents a signature of M using the signing key S_{N} of the programmable node N, and Ver_{P}_{_{N}} (S) represents verification of a signature S using the verification key P_{N} of the programmable node N.

The programmable node F that receives the signature S of the verification key of the programmable node C verifies the signing key S_{C} of the programmable node C using the verification key P_{SSVK} of the SSVK which is previously stored in step 130 of FIG. 2, as follows.
Ta=R⁻¹{Ver_{P}_{_{SSVK}}(S_{C})}=ID_{C}, P_{C} (12)

After the signing key S_{C} of the programmable node C is verified using Equation 12, the verification key P_{C} of the programmable node C is obtained using a redundancy function.

The programmable node F verifies the programmable packet I_{C} using the verification key P_{C} of the programmable node C as follows.
Qc=R⁻¹{Ver_{P}_{_{C}}(Sig_{S}_{_{C}}(R(PC, RESULT_{C})))}=PC, RESULT_{C} (13)

After the programmable packet I_{C} is verified using Equation 13, the programmable node F obtains the PC contained in the programmable packet I_{C} and the execution result RESULT_{C} thereof, in step 290.

Then the programmable node F confirms the execution result RESULT_{C} of the PC, obtains an execution result RESULT_{F} of the PC obtained in step 290 with respect to the programmable node F by executing the PC, and terminates a programmable packet transfer protocol, in step 292.

In Equations 12 and 13, R⁻¹(M) represents an inverse redundancy function of M, Sig_{S}_{_{N}} (M) represents a signature of M using the signing key S_{N} of the programmable node N, and Ver_{P}_{_{N}} (S) represents verification of a signature S using the verification key P_{N} of the programmable node N.

As described above, a method of transferring a programmable packet according to the present invention performs verification with respect to programmable nodes using digital signatures having a high-security signing key. A digital signing algorithm cannot be forged. Since it is impossible to forge a signature by a third party and the SSVK functions as an authentication authority, mutual authentication between nodes can be achieved. Also, since the right to verify signatures is restricted by access limit performed by the SSVK, a third party (i.e., a person who has no right to access the SSVK) cannot confirm signed contents. In this case, a verification key is long, it is not easy for a third party to create the verification key.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While this invention has been particularly shown and described with reference to an embodiment thereof, it will be understood by those skilled in the art that various changes in form and details may be made therein without departing from the spirit and scope of the invention as defined by the appended claims. The embodiments should be considered in descriptive sense only and not for purposes of limitation. Therefore, the scope of the invention is defined not by the detailed description of the invention but by the appended claims, and all differences within the scope will be construed as being included in the present invention.

1. A method of registering a programmable node to transfer a programmable packet, the method comprising:
(a) creating a signing key and a verification key of the programmable node;
(b) showing identification information and the verification key of the programmable node to a storage server for verification keys and requests for registration;
(c) storing in a database of the storage server the signing key of the programmable node in which the identification information and the verification key are signed by a signing key of the storage server;
(d) the storage server issuing the signing key of the programmable node and the verification key of the storage server to the programmable node; and
(e) storing the signing key of the programmable node and the verification key of the storage server in the programmable node.

2. The method of claim 1, wherein the identification information is an IP address of the programmable node.

3. The method of claim 1, wherein the signing key of the programmable node signed in step (c) is expressed as follows:
S_{N}={Sig_{S}_{_{SSVK}}(R(ID_{N}, P_{N}))},
where ID_{N} represents the IP address of the programmable node, P_{N} represents the verification key of the programmable node, R(M) represents a redundancy function of M, and Sig_{S}_{_{N}} (M) represents signing of M using the signing key (S_{N}) of the programmable node N.

4. A method of transferring a programmable packet, the method comprising:
(a) calculating a redundancy function value of a target program code at a start node and signing the redundancy function value using a signing key of the start node;
(b) creating a programmable packet based on an IP address, a final destination IP address, and information required for signing and verification that belong to the start node and transferring the created programmable packet to a neighboring node;
(c) forwarding the programmable packet to the neighboring node, if a receipt node that receives the programmable packet transferred in step (b) is a general node;
(d) creating a programmable packet containing a program code included in the programmable packet and an intermediate execution result of the program code and transferring the programmable packet to the neighboring node, if a receipt node that receives the programmable packet transferred in step (b) is not a general node; and
(e) executing the program code included in the programmable packet and obtaining a final result, if a receipt node that receives the programmable packet transferred in step (b) or (d) is a final node.

5. The method of claim 4, wherein the programmable packet created in step (b) is expressed as follows:
Ia={Sig_{S}_{_{A}}(R(PC)), ID_{A}, ID_{F}, DATA},
where ID_{A} represents the IP address of the start node, ID_{F} represents an IP address of the final destination, DATA represents the information required for signing and verification, R(PC) represents the redundancy function value of the target program code, and Sig_{S}_{_{N}} (M) represents signing of M using a signing key (S_{N}) of a programmable node (N).

6. The method of claim 4, wherein step (d) further comprises:
(d-1) the receipt node composing a packet (J) with a result of signing an IP address of a transfer node that transfers the programmable packet and a redundancy function value of a verification key request message for the transfer node using a signing key of the receipt node and the IP address of the receipt node and transferring the packet (J) to the storage server;
(d-2) the storage server confirming based on the IP address of the receipt node included in the packet J that the receipt node is a registered node;
(d-3) the storage server verifying a signature using a verification key of the receipt node, copying a signing key with respect to a verification key of the transfer node, and transferring the copied signing key to the IP address of the receipt node;
(d-4) the receipt node verifying the verification key of the transfer node using a verification key of the storage server and obtaining the verification key of the transfer node using a redundancy function;
(d-5) the receipt node verifying the programmable packet using the verification key of the transfer node and executing the program code included in the programmable packet; and
(d-6) the receipt node composing the programmable packet using the program code and an execution result of the program code and transferring the programmable packet to the neighboring node.

7. The method of claim 6, wherein the packet (J) composed in step (d-1) is expressed as follows:
Ja={(Sig_{S}_{_{C}}(R(REQUEST(P_{A}), ID_{A}))), ID_{C}}
where R(REQUEST(P_{A}), ID_{A}) represents a redundancy function value with respect to the verification key request message of the transfer node and the IP address of the receipt node, ID_{C} represents the IP address of the receipt node, and Sig_{S}_{_{N}} (M) represents a signature of M using the signing key (S_{N}) of the programmable node (N).

8. The method of claim 6, wherein in step (d-2), the storage server confirms that the receipt node is a registered node using the following equation:
$$\begin{matrix}Ka = {R}^{- 1} \{ {Ver}_{{P}_{C}} ( {Sig}_{{S}_{C}} ( R ( REQUEST ( {P}_{A} ) , {ID}_{A} ) ) ) \} \\ = ( REQUEST ( {P}_{A} ) , {ID}_{A} )\end{matrix} ,$$
where REQUEST (P_{A}) represents the verification key request message of the transfer node, R(REQUEST(P_{A}), ID_{A}) represents a redundancy function value with respect to the verification key request message of the transfer node and the IP address of the receipt node, ID_{C} represents the IP address of the receipt node, Sig_{S}_{_{N}} (M) represents a signature of M using the signing key (S_{N}) of the programmable node (N), and Ver_{P}_{_{N}} (S) represents verification of a signature (S) using the verification key (P_{N}) of the programmable node (N).

9. The method of claim 6, wherein the signing key with respect to the verification key of the transfer node, which is copied in step (d-3), is expressed as follows:
S_{A}={Sig_{S}_{_{SSVK}}(R(ID_{A}, P_{A}))},
where R(ID_{A}, P_{A}) represents the redundancy function value with respect to the IP address of the transfer node and the verification key of the transfer node and Sig_{S}_{_{N}} (M) represents signature using the signing key (S_{N}) of the programmable node (N).

10. The method of claim 6, wherein in step (d-4), the signing key of the transfer node is verified using the following equation:
Ta=R⁻¹{Ver_{P}_{_{SSVK}}(S_{A})}=(ID_{A}, P_{A}),
where ID_{A} represents the IP address of the transfer node, P_{A} represents the verification key of the transfer node, S_{A} represents the signing key of the transfer node, R⁻¹(M) represents an inverse redundancy function of M, Sig_{S}_{_{N}} (M) represents signature using the signing key (S_{N}) of the programmable node (N), and Ver_{P}_{_{N}} (S) represents verification of the signature (S) using the verification key (P_{N}) of the programmable node (N).

11. The method of claim 6, wherein in step (d-5), the programmable packet is verified using the following equation:
Qa=R⁻¹{Ver_{P}_{_{A}}(Sig_{S}_{_{A}}(R(PC)))}=PC,
where R(PC) represents the redundancy function value with respect to the target program code, R⁻¹(M) represents an inverse redundancy function of M, Sig_{S}_{_{N}} (M) represents signature using the signing key (S_{N}) of the programmable node (N), and Ver_{P}_{_{N}} (S) represents verification of the signature (S) using the verification key (P_{N}) of the programmable node (N).

12. The method of claim 6, wherein the programmable packet created in step (b-6) is expressed as follows:
I_{C}={Sig_{S}_{_{C}}(R(PC, RESULT_{C})), ID_{C}, ID_{F}, DATA},
where ID_{C} represents the IP address of the start node, ID_{F} represents the IP address of the final destination, DATA represents information required for signing and verification, R(PC) represents the redundancy function value with respect to the target program code, Sig_{S}_{_{N}} (M) represents signature using the signing key (S_{N}) of the programmable node (N), RESULT_{C} represents a result of executing the program code by a programmable node (C).

13. The method of claim 4, wherein step (e) further comprises:
(e-1) composing a packet (J) with a result of signing an IP address of the transfer node that transfers the programmable packet and a redundancy function value of a verification key request message for the transfer node using a signing key of the final node and the IP address of the final node and transferring the packet (J) to the storage server;
(e-2) the storage server confirming based on the IP address of the final node included in the packet J that the final node is a registered node;
(e-3) the storage server verifying a signature using a verification key of the final node, copying a signing key with respect to a verification key of the transfer node, and transferring the copied signing key to the IP address of the receipt node;
(e-4) the final node verifying the verification key of the transfer node using a verification key of the storage server and obtaining the verification key of the transfer node using a redundancy function;
(e-5) the final node verifying the programmable packet using the verification key of the transfer node and executing the program code and the execution result of the program code of the transfer node from the programmable packet; and
(e-6) the final node checking the execution result of the transfer node, executing the program code obtained in step (e-5), and obtaining the execution result of the program code of the final node.

14. The method of claim 13, wherein the packet (J) composed in step (e-1) is expressed as follows:
Jc={(Sig_{S}_{_{F}}(R(REQUEST(P_{C}), ID_{C}))), ID_{f}},
where R(REQUEST(P_{C}), ID_{C}) represents a redundancy function value with respect to the verification key request message of the transfer node and the IP address of the receipt node, ID_{F} represents the IP address of the receipt node, and Sig_{S}_{_{N}} (M) represents a signature of M using the signing key (S_{N}) of the programmable node (N).

15. The method of claim 13, wherein in step (e-2), the storage server confirms that the receipt node is a registered node using the following equation:
$$\begin{matrix}Kc = {R}^{- 1} \{ {Ver}_{{P}_{F}} ( {Sig}_{{S}_{F}} ( R ( REQUEST ( {P}_{C} ) , {ID}_{C} ) ) ) \} \\ = ( REQUEST ( {P}_{C} ) , {ID}_{C} )\end{matrix} ,$$
where REQUEST (P_{C}) represents the verification key request message of the transfer node, R(REQUEST(P_{C}), ID_{C}) represents a redundancy function value with respect to the verification key request message of the transfer node and the IP address of the receipt node, ID_{F} represents the IP address of the receipt node, Sig_{S}_{_{N}} (M) represents a signature of M using the signing key (S_{N}) of the programmable node (N), and Ver_{P}_{_{N}} (S) represents verification of a signature (S) using the verification key (P_{N}) of the programmable node (N).

16. The method of claim 13, wherein the signing key with respect to the verification key of the transfer node, which is copied in step (e-3), is expressed as follows:
S_{C}={Sig_{S}_{_{SSVK}}(R(ID_{C}, P_{C}))},
where R(ID_{C}, P_{C}) represents the redundancy function value with respect to the IP address of the transfer node and the verification key of the transfer node and Sig_{S}_{_{N}} (M) represents signature using the signing key (S_{N}) of the programmable node (N).

17. The method of claim 13, wherein in step (e-4), the signing key of the transfer node is verified using the following equation:
Tc=R⁻¹{Ver_{P}_{_{SSVK}}(S_{C})}=(ID_{C}, P_{C}),
where ID_{C} represents the IP address of the transfer node, P_{C} represents the verification key of the transfer node, S_{C} represents the signing key of the transfer node, R⁻¹(M) represents an inverse redundancy function of M, Sig_{S}_{_{N}} (M) represents signature using the signing key (S_{N}) of the programmable node (N), and Ver_{P}_{_{N}} (S) represents verification of the signature (S) using the verification key (P_{N}) of the programmable node (N).

18. The method of claim 13, wherein in step (e-5), the programmable packet is verified using the following equation:
Qc=R⁻¹{Ver_{P}_{_{C}}(Sig_{S}_{_{C}}(R(PC)))}=PC,
where R(PC) represents the redundancy function value with respect to the target program code, R⁻¹(M) represents an inverse redundancy function of M, Sig_{S}_{_{N}} (M) represents signature using the signing key (S_{N}) of the programmable node (N), and Ver_{P}_{_{N}} (S) represents verification of the signature (S) using the verification key (P_{N}) of the programmable node (N).

19. A computer readable medium having embodied thereon a program for a method of registering a programmable node to transfer a programmable packet, the method comprising:
(a) creating a signing key and a verification key of the programmable node;
(b) showing identification information and the verification key of the programmable node to a storage server for verification keys and requests for registration;
(c) storing in a database of the storage server the signing key of the programmable node in which the identification information and the verification key are signed by a signing key of the storage server;
(d) the storage server issuing the signing key of the programmable node and the verification key of the storage server to the programmable node; and
(e) storing the signing key of the programmable node and the verification key of the storage server in the programmable node.

20. A computer readable medium having embodied thereon a program for a method of transferring a programmable packet, the method comprising:
(a) calculating a redundancy function value of a target program code at a start node and signing the redundancy function value using a signing key of the start node;
(b) creating a programmable packet based on an IP address, a final destination IP address, and information required for signing and verification that belong to the start node and transferring the created programmable packet to a neighboring node;
(c) forwarding the programmable packet to the neighboring node, if a receipt node that receives the programmable packet transferred in step (b) is a general node;
(d) creating a programmable packet containing a program code included in the programmable packet and an intermediate execution result of the program code and transferring the programmable packet to the neighboring node, if a receipt node that receives the programmable packet transferred in step (b) is not a general node; and
(e) executing the program code included in the programmable packet and obtaining a final result, if a receipt node that receives the programmable packet transferred in step (b) or (d) is a final node.
